(19) United States
(12) Patent Application Publication
(10) Pub. No.: US 2007/0129882 A1
(43) Pub. Date: Jun. 7, 2007

(54) Route searching method for navigation system, and navigation system

(76) Inventors: Katsumi Sano, Kanagawa (JP); Kazuhiro Toma, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/581,691

(22) PCT Filed: May 23, 2005
(86) PCT No.: PCT/JP05/09336

§ 371 Date: Jun. 6, 2006

(30) Foreign Application Priority Data
Jun. 17, 2004 (JP) 2004-179852

(51) Int. Cl. G01C 21/00

(52) U.S. Cl. 701/209; 701/201

(57) ABSTRACT

A navigation system which shortens a time period from the setting of a destination to the presentation of a recommended route.

The navigation system to be mounted on a vehicle is provided with a storage device 3 stored with link information and a processor 1. This processor 1 is caused to execute: the process to detect stop of the vehicle; the process to detect a current position of the vehicle in case the stop of the vehicle is detected or in case the navigation system itself is started; the process to search a route from the detected current position to an intersection within a range of a predetermined distance, by using the link information; the process to accept a setting of the destination; and the process to search a route from the intersection to the destination by using the link information, in case the setting of the destination is accepted, to specify a route which is composed of the route searched from the current position to the intersection and the route searched from the intersection to the destination, as a recommended route.

### TECHNICAL FIELD

The present invention relates to a navigation system and, more particularly, to a route searching technique of a vehicle-mounted navigation system.

### BACKGROUND ART

A known navigation system is such that it searches a recommended route set from a current position to a destination by using link information (for example, Patent Document 1). The navigation system, as described in Patent Document 1, accepts the setting of a destination from a user, and starts the search of the recommended route to the set destination.

Patent Document 1: Japanese Patent Laid-open Publication No. H6-331379

### DISCLOSURE OF THE INVENTION

### Problem to be Solved by the Invention

The navigation system performs operations to search a route capable of reaching a destination at an optimum cost by using Dijkstra's algorithm or the like. Most of these route searching operations generally take a long time. On the other hand, the user is thought to desire a presentation of the recommended route within a short time after the destination was set.

However, Patent Document 1 has taken it into consideration to simplify the operations for the user to set the destination but has not especially taken it consideration to present the searched route to the set destination to the user within a short time period.

The invention has been conceived in view of the background thus far described, and has an object to provide a navigation system capable of shortening a time period from the setting of a destination to the presentation of a recommended route.

### MEANS FOR SOLVING THE PROBLEM

In order to solve the aforementioned problems, one mode of the invention is applied to a navigation system which is mounted on a vehicle to search a recommended route to a destination by using link information. The navigation system executes: the step of detecting as top of the vehicle; the step of detecting a current position of the vehicle in case the stop of the vehicle is detected or in case the navigation system itself is started; the step of searching a route from the detected current position to an intersection within a range of a predetermined distance, by using the link information; the step of accepting a setting of the destination; and the step of searching a route from the intersection to the destination by using the link information, in case the setting of the destination is accepted and specifying a route which is composed of the route from the searched current position to the intersection and the route from the searched intersection to the destination, as a recommended route.

In order to solve the aforementioned problems, another mode of the invention is applied to a navigation system which is mounted on a vehicle to search a recommended route to a destination by using link information. Here, a display device is connected with the navigation system.

Moreover, the navigation system executes: the step of detecting the current position of the vehicle; the step of accepting an input of the destination from a user; the step of displaying a screen to accept confirmation from the user whether or not the destination accepted is erroneous, on the display device; the step of setting the destination in case data indicating that the destination from the destination is not erroneous is accepted from the user; the step of searching the route from the detected current position to the accepted destination, by using the link information before the destination is set, in case the input of the destination is accepted; and the step of specifying the searched route as a recommended route in case the destination is set.

### EFFECTS OF THE INVENTION

Thus, according to the invention, the navigation system detects the current position of the vehicle, in case it detects the stop of the vehicle or in case navigation system itself is started, to determine the intersection within the range of a predetermined distance from the detected current position thereby to search the route from the current position to the determined intersection. Then, the navigation system searches, in case it accepts the setting of the destination, the recommended route to the destination by making use of the route from the current position already searched to the intersection.

In case the setting of the destination is accepted, therefore, the operations to search the route from the current position to the intersection within the predetermined range can be omitted to shorten the time period for searching the recommended route to the destination.

In another mode of the invention, on the other hand, in case the input of the destination from the user is accepted, the destination is set in case the data indicating confirmation by the user that the destination is not erroneous is accepted. According to another mode of the invention, moreover, the search of the route to the destination is started at the stage of accepting input of the destination before the destination is set.

In case the destination is set, therefore, the search of the recommended route to the destination has already been started, so that the searching time period from the final setting of the destination can be shortened.

### BRIEF DESCRIPTION OF THE DRAWINGS

FIG. 1 is a schematic configuration diagram of a vehicle-mounted navigation system, to which an embodiment of the invention is applied.

FIG. 2 is a diagram simulating a data structure of map data stored in a storage device of the embodiment of the invention.

FIG. 3 is a diagram which explains the functional configurations of a processor of the embodiment of the invention.

FIG. 4 is a diagram showing a hardware configuration of the processor of the embodiment of the invention.

FIG. 5 is a diagram which explains a flow of the route searching process to be carried out when the navigation system of the embodiment of the invention is started.

FIG. 6 is a diagram which explains a route searching process to be executed in case the navigation system of the embodiment of the invention detects that the vehicle has stopped.

### DESCRIPTION OF REFERENCE NUMERALS AND SIGHS

1 - - - Processor, 2 - - - Display, 3 - - - Storage Device, 4 - - - Voice Input/Output Device, 5 - - - Input Device, 6 - - - Wheel Speed Sensor, 7 - - - Terrestrial Magnetism Sensor, 8 - - - Gyro, 9 - - - GPS Receiver, 10 - - - Setting Unit, 11 - - - Current Position Detecting Unit, 12 - - - Data Reading Unit, 13 - - - Map Match Processing Unit, 14 - - - Route Searching Unit, 15 - - - Route Guide Unit, 16 - - - Map Display Processing Unit, 17 - - - Graphics Processing Unit, 21 - - - CPU, 22 - - - RAM, 23 - - - ROM, 24 - - - DMA, 25 - - - Drawing Controller, 26 - - - VRAM, 27 - - - Color Pallet, 28 - - - A/D Converter, 29 - - - SCI, 30 - - - PIO, and 31 - - - Counter.

### BEST MODE FOR CARRYING OUT THE INVENTION

An embodiment of the invention is described in the following with reference to the accompanying drawings.

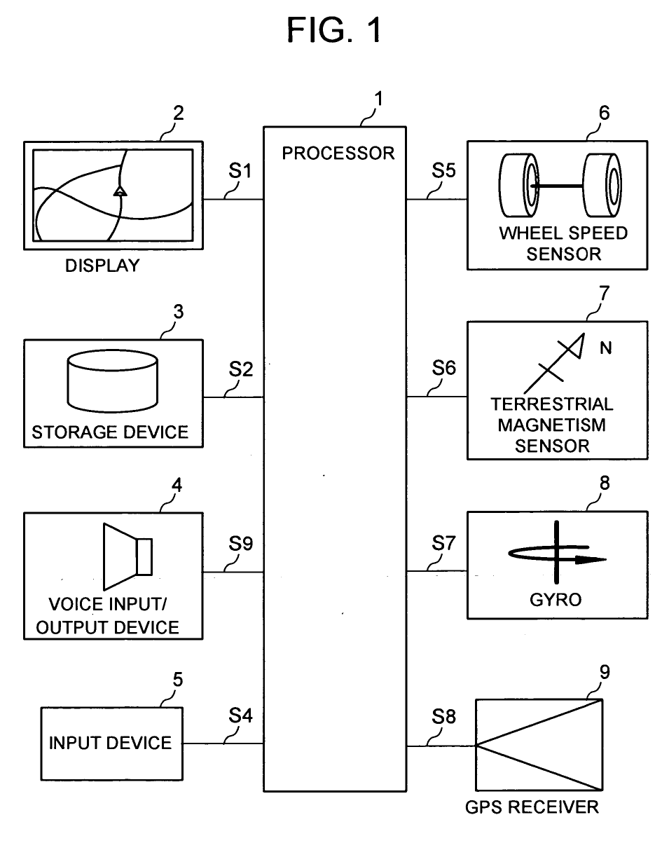

First of all, a schematic configuration of a vehicle-mounted navigation system, to which the embodiment is applied, is described with reference to FIG. 1.

FIG. 1 is a schematic configuration diagram of a vehicle-mounted navigation system (hereinafter, referred simply to the “navigation system”), to which the embodiment of the invention is applied.

As shown, the navigation system is configured to include a processor 1, a display 2, a storage device 3 stored with map data and so on, a voice input/output device 4, an input device 5, a wheel speed sensor 6, a terrestrial magnetism sensor 7, a gyro 8 and a GPS (Global Positioning System) receiver 9.

The processor 1 is a central unit which processes various pieces of information provided for the user by the navigation system. On the basis of the information outputted from the various sensors 6 to 8 and the GPS receiver 9, for example, the processor 1 detects the current position. The processor 1 reads map data around the current position detected, from the storage device 3, develops the read map data graphically and displays the map data together with a mark indicating the current position on the display 2.

At a stage before acceptance of the setting of a destination, on the other hand, the processor 1 searches in advance a route to join two points: the current position of the vehicle and an intersection contained in a predetermined range from the current position. In case the destination is set, moreover, the processor 1 executes the search of a recommended route to the destination by making use of the route to the intersection contained in the predetermined range searched in advance. The process to search the recommended route to the destination will be described in detail hereinafter.

The display 2 is a unit which displays graphic data created by the processor 1, and is configured of a CRT, a liquid crystal display or the like. The processor 1 and the display 2 are generally connected by a signal S1 such as an RGB signal or an NTSC (National TV Standards Committee) signal.

The storage device 3 is a unit stored with map data corresponding to multi-scale maps from the entire map of the Japanese Islands to the detailed maps of cities, towns and villages of Japan and the like. For example, a DVD device or a hard disk device can also be used as the storage device 3.

The configuration of the map data is described in the following.

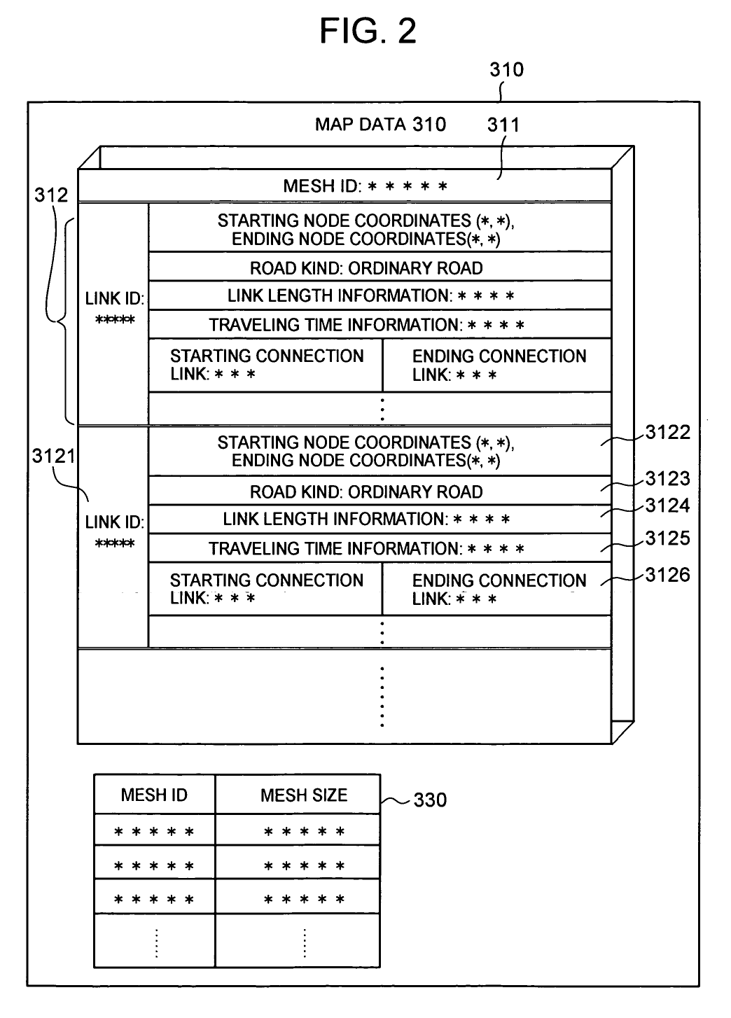

FIG. 2 is a diagram simulating a data structure of the map data stored in the storage device 3.

As shown, map data 310 is classified into every mesh areas, which are obtained by dividing a map into plural pieces. The map data 310 has mesh ID 311 which identifies the mesh areas, and link data 312 of individual links composing a road contained in the mesh areas. In the map data 310, moreover, each mesh ID 311 contains a mesh size list 330, in which the data sizes (or the mesh size) of the link data 312 of the mesh area defined by that mesh ID are made to correspond to one another.

The link data 312 includes: a link ID 3121 which identifies the link; coordinate information 3122 of two nodes (a starting node and an ending node) composing the link; a road kind 3123 indicating which of a “toll road” or an “ordinary road” the linked road belongs to; link length information 3124 indicating the length of the link; traveling time (or moving time) information 3125 of the link; and a link ID (or a connection link ID) 3126 of the link connecting with the two nodes each (i.e., the starting node and the ending node).

The mesh size list 330 is used to confirm the data size of the map data to be read from the storage device 3 when the processor 1 performs the route search. Specifically, the processor 1 reads and holds the mesh size list 312 from the storage device 3 when the navigation system is started. The map data 310 also contains the information (e.g., names, kinds or coordinate information) of the map components contained in the corresponding mesh area excepting the road.

The description is continued by reverting to FIG. 1. The voice input/output device 4 converts the message, to the user as created by the processor 1, into a voice signal and outputs it, recognizes the voice uttered by the user, and transfers the recognized contents to the processor 1.

The input device 5 is a unit which accepts an instruction of the user such as a selection of various functions or a setting of the destination of the navigation system, and is configured of a hard switch such as a scroll key or a scale changing key, a joy stick, or a touch panel adhered to the display 2.

The sensors 6 to 8 and the GPS receiver 9 are used by the navigation system to detect the current position. The wheel speed sensor 6 measures the distance from the circumference of the wheels and from the number of wheel revolutions measured, and the turning angle of the mover from the revolution numbers of the paired wheels. The terrestrial magnetism sensor 7 detects the magnetism owned by the earth, thereby to get the bearings of the mover. The gyro 8 is composed of an optical fiber gyro or a vibration gyro to detect the angle, by which the mover has turned. The GPS receiver 9 receives the signals from GPS satellites to measure the distances between the mover and three or more GPS satellites and the rates of change of the distances thereby to detect the current position, the traveling direction and the traveling azimuth of the mover.

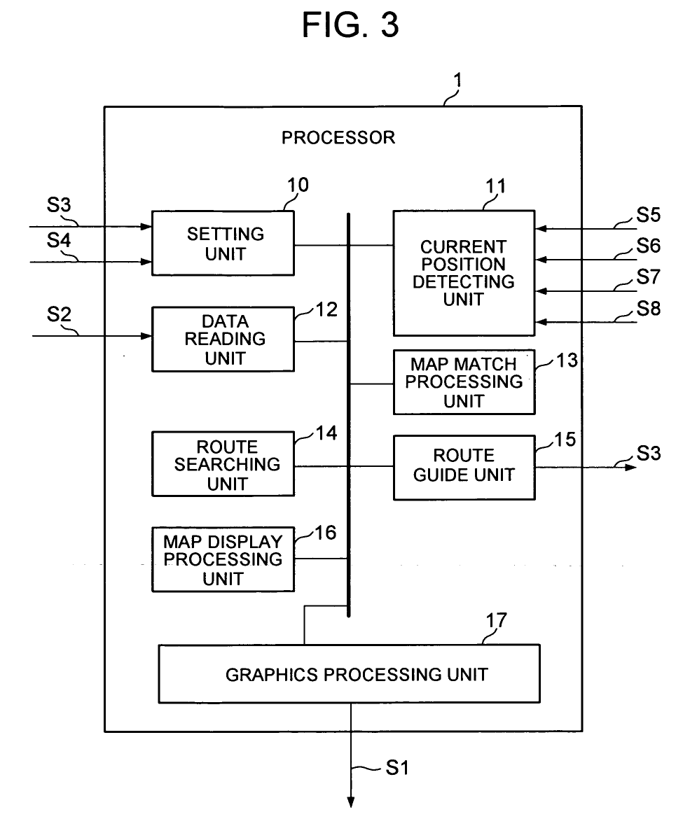

Subsequently, the functions owned by the processor 1 of the navigation system thus far described are explained with reference to FIG. 3.

FIG. 3 is a diagram which explains the functional configurations of the processor 1 of this embodiment.

As shown, the processor 1 is configured to include a setting unit 10, a current position detecting unit 11, a data reading unit 12, a map match processing unit 13, a route searching unit 14, a route guide unit 15, a map display processing unit 16, a graphics processing unit 17 and a mesh size list acquisition unit.

The setting unit 10 accepts the demand inputted to the input device 5 or the voice input/output device 4 by the user, and controls the processor 1 so that a processing corresponding to the contents demanded may be executed. For example, the route searching unit 14 is demanded for a processing to search the recommended rout from the current position to the destination, in case the user demands the search for the recommended route to the destination through the input device 5.

The current position detecting unit 11 integrates the distance data and the angle data, which are obtained by individually integrating distance pulse data S5 measured by the wheel speed sensor 6 and angular velocity data S7 measured by the gyro sensor 8, with respect to a time axis, thereby to periodically operate a current position (X′, Y′) or the position after a travel, from an initial value (X, Y). The current position detecting unit 11 outputs the current position calculated, to the map display processing unit 16, and the calculated present position at every predetermined calculation to the map match processing unit 13. Moreover, the current position detecting unit 11 outputs, in case it acquires corrected data of the current position from the later-described map match processing unit 13, the corrected data of the current position to the map display processing unit 16. Still moreover, the current position detecting unit 11 outputs the current position (or its corrected data), if demanded, to the route guide unit 15.

In order to bring the turned angle of the vehicle of the driver and the traveling direction into a coincident relation, the current position detecting unit 11 refers to azimuth data S6 obtained from the terrestrial magnetism sensor 7 and the angular data integrated from the angular velocity data S7 obtained from the gyro 8, thereby to estimate the absolute azimuth of the direction, in which the vehicle travels. If the data S5 of the wheel speed sensor 6 and the data S7 of the gyro 8 are individually integrated, their errors are accumulated. Therefore, the current position detecting unit 11 cancels the errors which are accumulated on the basis of position data S8 obtained for a predetermined period from the GPS receiver 9, thereby to determine the data of the current position.

The data reading unit 12 reads map data 31 in the area demanded to be displayed on the display 2 or in the area (containing the current position and the destination) to be demanded for the route search, from the storage device 3.

The map match processing unit 13 processes the map match between the map data of the periphery of the current position, which is read by the data reading unit 12, and the current position which is periodically detected by the current position detecting unit 11. The map match processing unit 13 corrects the current position periodically, and outputs the data indicating the corrected current position to the current position detecting unit 11.

By using the Dijkstra's algorithm etc, the route searching unit 14 searches the route, which joins the two points (e.g., the current position and the destination) to reach the destination at the optimum cost, with the link data 312 (referred to FIG. 2). The route searching unit 14 outputs the data indicating the recommended route to the map display processing unit 16 so that the route obtained as the result of the search may be displayed as the recommended route on the display 2. The route searching unit 14 further outputs the data indicating the recommended route searched, to the route guide unit 15.

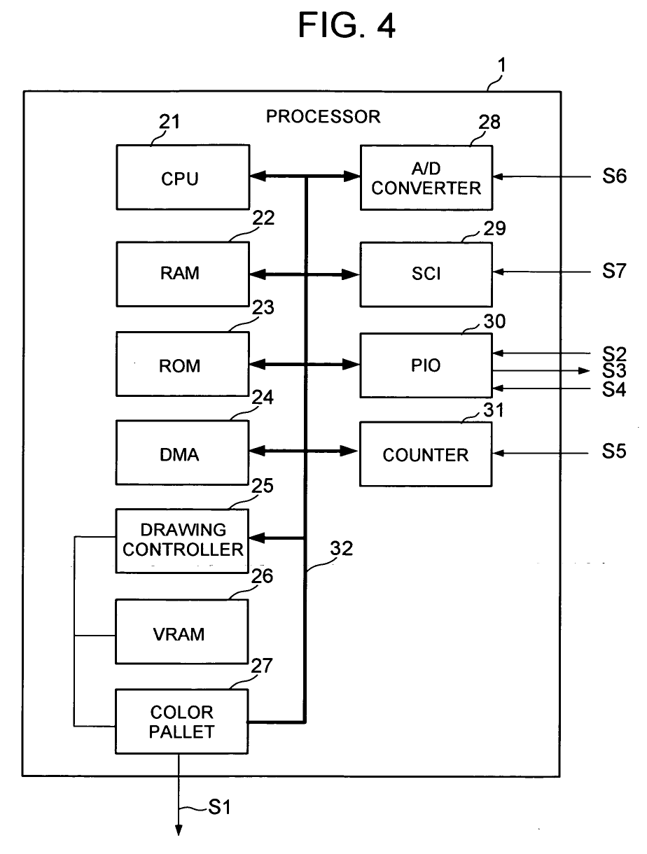

When the navigation system is started, moreover, the route searching unit 14 of this embodiment acquires the mesh size list 310 in the map data 310 stored in the storage device 3, through the data reading unit 12. Then, the route searching unit 14 stores the acquired mesh size list 310 in a predetermined area of a RAM 22 (referred to FIG. 4). With reference to the mesh size list 330 stored in the predetermined area of the RAM 22, the route searching unit 14 confirms at the route searching time whether or not the link data 312 of the mesh to be used for the route search can be developed on the RAM 22. After it is confirmed that the link data 312 of the mesh to be used for the route search can be developed on the RAM 22, the route searching unit 14 acquires that link data 312 through the data reading unit 12.

As thus explained in this embodiment, in case the navigation system is started, the route searching unit 14 reads the mesh size list 330 from the storage device 3 and stores it in the predetermined area of the RAM 22. Then, the route searching unit 14 refers to the mesh size list 330 stored in the RAM 22, when it acquires the link data 312, thereby to confirm whether or not the link data 312 can be developed on the RAM 22. In other words, when the link data 312 is to be acquired, the embodiment can realize it without any access to the storage device 3 whether or not the link data 312 can be developed on the RAM 22. In short, this embodiment can shorten the time period for acquiring the link data 312 at the time of processing the route search.

Moreover, the route searching unit 14 of this embodiment processes in advance, at the stage before the setting unit 10 accepts the setting of the destination from the user, the search of the route joining the two points, i.e., the current position of the vehicle, and the intersection contained within the predetermined range from the current position. In case the destination is set, then, the route searching unit 14 utilizes the route to the intersection, as searched in advance and contained within the predetermined range, thereby to execute the search of the recommended route to the destination. Thus, in this embodiment, the route search in the periphery of the current position of the vehicle is performed at the stage before the setting of the destination is accepted. In case the destination is set, therefore, it is possible to shorten the searching time period for searching the recommended route to the destination.

The route guide unit 15 guides the user to reach the destination via the recommended route searched. Specifically, the route guide unit 15 acquires the current position periodically from the current position detecting unit 11. Moreover, the route guide unit 15 guides the user to the destination by using the current position acquired, the data indicating the recommended route acquired from the route searching unit 14, and the map data read from the storage device 3 through the data reading unit 12. Here, this embodiment does not place any especial limit on the specific method for the route guide unit 15 to guide the user to the destination. For example, the route guide unit 15 displays the screen, in which the recommended route searched by the route searching unit 14 is laid over the map, on the display 2 thereby to inform the user through the voice input/output device 4, of the information (e.g., the information on whether or not the vehicle should turn at the next intersection) necessary for the vehicle to run on the recommended route.

The map display processing unit 16 receives the map data 310 in the area, which is demanded to be displayed on the display 2, from the storage device 3 through the data reading unit 12. The map display processing unit 16 receives the recommended route searched from the route searching unit 14, and receives the information on the current position from the current position detecting unit 11. Moreover, the map display processing unit 16 creates map drawing commands for drawing marks such as roads, other map components, the current position, the destination and arrows for route guide on the screen of the display 2, and outputs the map drawing commands to the graphics processing unit 17.

The graphics processing unit 17 displays graphic data on the screen of the display 2 with the map drawing commands created by the map display processing unit 16.

Subsequently, the hardware configuration of the processor 1 of this embodiment is described in the following.

FIG. 4 is a diagram showing a hardware configuration of the processor 1.

As shown, the processor 1 is configured to include: a CPU (Central Processing Unit) 21; the RAM (Random Access Memory) 22 which temporarily stores programs or data to be executed by the CPU 21; a ROM (Read Only Memory) 23 stored with programs which execute the functions the aforementioned individual units have (i.e., the setting unit 10, the current position detecting unit 11, the data reading unit 12, the map match processing unit 13, the route searching unit 14, the route guide unit 15, the map display processing unit 16 and the graphics processing unit 17); a DMA (Direct Memory Access) 24 which transfers data between the memories and between the memories and the individual devices; a drawing controller 25 which executes a graphic drawing and which controls the display; a VRAM (Video Random Access Memory) 26 which stores graphics image data; a color pallet 27 which converts image data into RGB signals; an A/D converter 28 which converts analog signals into digital signals; an SCI (Serial Communication Interface) 29 which converts serial signals into parallel signals synchronized with a bus; a PIO (Parallel Input/Output) 30 which superimposes the parallel signals on the bus in synchronism with the bus; and a counter 31 which integrates pulse signals. The functions of the aforementioned individual units (i.e., the setting unit 10, the current position detecting unit 11, the data reading unit 12, the map match processing unit 13, the route searching unit 14, the route guide unit 15, the map display processing unit 16 and the graphics processing unit 17) are realized such that the CPU 21 loads the RAM 22 with the programs, which are stored in the ROM 23 to execute the functions owned by the individual units, and executes those programs.

Subsequently, the processing to be executed by the navigation system of this embodiment to search the recommended route is described in the following. At first, the route searching process to be executed when the navigation system is started is described in the following.

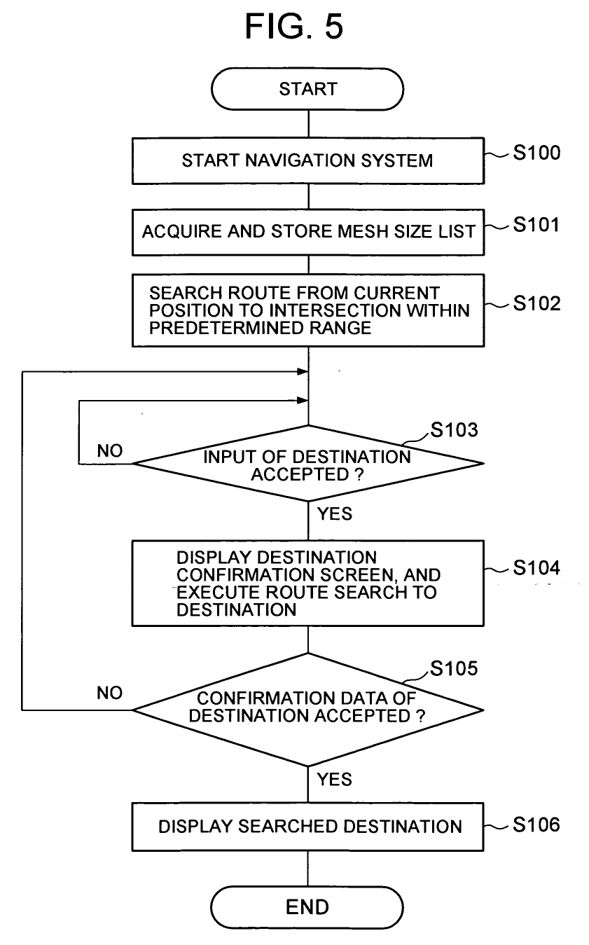

FIG. 5 is a diagram which explains a flow of the route searching process to be carried out when the navigation system of this embodiment is started.

The route searching unit 14 of the processor 1 starts the following operations in case the navigation system is started (at S100).

At first, the route searching unit 14 acquires the mesh size list 330 stored in the storage device 3, through the data reading unit 12, and stores the same in a predetermined area of the RAM 22 (at S101). This mesh size list 330 is utilized every time when the route searching unit 14 acquires the link data 312 of the mesh necessary for the route search, through the data reading unit 12.

Subsequently, the route searching unit 14 acquires the current position of the vehicle from the current position detecting unit 11, and determines the intersection which exists within a range of a predetermined distance from the periphery of the current position. Then, the route searching unit 14 searches the route from the current position to the intersection detected (at S102).

Specifically, the route searching unit 14 specifies the mesh which is contained in the range of a predetermined distance from the current position. The route searching unit 14 acquires the link data 312 of the mesh specified, from the storage device 3 through the data reading unit 12. Here, the route searching unit 14 refers, in case it acquires the link data 312 of the specified mesh, to the mesh size list 330 stored in the predetermined area of the RAM 22. Confirming the data size of the link data 312 of the specified mesh corresponding to the mesh size list 330 and the capacity of the RAM 22, the route searching unit 14 sequentially acquires the link data 312 developable to the RAM 22.

Then, the route searching unit 14 uses the link data 312 acquired, to determine the intersection which exists in a predetermined distance range from the current position. With this acquired link data 312, the route searching unit 14 searches the route from the current position to the aforementioned intersection determined. In case a plurality of intersections exist in the predetermined distance range from the current position, the route searching unit 14 searches the routes from the current position to the individual intersections, for the plural intersections. Then, the route searching unit 14 holds the searched routes from the current position to the intersections.

Subsequently, the route searching unit 14 advances to S104, in case it accepts the input of the destination from the user through the setting unit 10 (at S103).

At S104, the route searching unit 14 displays such a screen (or a confirmation screen) on the display 2 as to accept a confirmation of whether or not the inputted destination is erroneous, from the user. Moreover, the route searching unit 14 starts the search of the recommended route to the destination accepted at S103, at the stage before it accepts the data (the destination settlement data) from the user indicating that the destination is not erroneous (destination settlement data).

Specifically by using the current position and the accepted destination, the route searching unit 14 specifies the mesh to be utilized for the route search. With reference to the mesh size list 330 stored in the RAM 22, the route searching unit 14 confirms the data size of the link data of the specified mesh corresponding to the mesh size list 330 and the data size developable to the RAM. As a result of this confirmation, the route searching unit 14 acquires the link data 312 developable to the RAM 22, sequentially through the data reading unit 12. By using the link data 312 acquired, the route searching unit 14 searches the route, as determined at S102, from the intersection to the destination. Moreover, the route searching unit 14 obtains the route which is composed of the route determined at S102 from the current position to the intersection and the route determined from the intersection to the destination.

Subsequently, the route searching unit 14 advances to the operation of S106, in case it accepts the “destination settlement data” from the user. In case the search of the route started at S104 is not ended, the route searching unit 14 continues the searching operation. On the other hand, the route searching unit 14 quits, in case it accepts the “data indicating that the destination is erroneous” from the user, the route searching process started at S104, clears (or erases) in case the route searching process has already ended, the searched route, and the process returns to the operation of S103.

At S106, the route searching unit 14 specifies the route, which is obtained as a result of the route searching process started at S104, as the recommended route, and displays the recommended route specified on the display 2. Then, the route searching unit 14 outputs the specified recommended route to the route guide unit 15, and the process is ended.

Here, the description thus far made is on the case, in which the user inputs the data indicating the destination to the navigation system, but the invention should not be limited thereto. For example, the setting unit 10 accepts retrieval conditions such as an “address” or a “telephone number”, and the navigation system is provided with a retrieval function to retrieve the destination in accordance with the retrieval conditions accepted. The setting unit 10 outputs, in case the destination is retrieved by the retrieval function, the retrieved destination to the route searching unit 14. Moreover, the route searching unit 14 may start the route search, as accepted from the setting unit 10, to the destination, at the stage before the setting unit 10 accepts the confirmation of the retrieved destination from the user.

Subsequently an explanation will be made on the route searching process of the case, in which the navigation system of this embodiment detects that the vehicle stops.

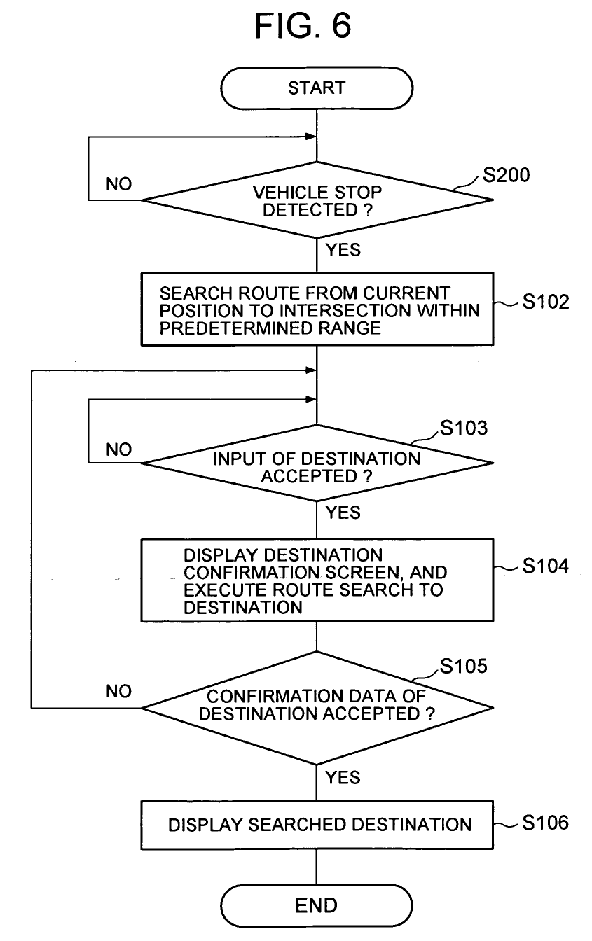

FIG. 6 is a diagram which explains a route searching process to be executed in case the navigation system of this embodiment detects that the vehicle stops.

Now, the route searching unit 14 of the navigation system periodically acquires the information from the vehicle speed sensor (not-shown), thereby to detect whether or not the vehicle has stopped (at S200). The route searching unit 14 advances to the operation of S102, in case it detects the stop of the vehicle. On the other hand, in case the route searching unit 14 does not detect the stop of the vehicle, it repeats the operation of S200.

After this, the route searching unit 14 performs the same operations as those of S102 to S106, which have been described with reference to FIG. 5.

Thus, according to this embodiment, in case the navigation system is started, the route searching unit 14 reads the mesh size list 330 from the storage device 3, and stores it in a predetermined area of the RAM 22. At the route searching time, therefore, the route searching unit 14 can realize an operation to confirm whether or not the link data of the mesh necessary for the search can be developed on the RAM 22 without any access to the storage device 3. In this embodiment, therefore, it is resultantly possible to shorten the time period for the route searching.

At the stage before the setting unit 10 accepts the setting of the destination from the user, moreover, the route searching unit 14 of this embodiment searches a route in advance that joins the two points: the current position of the vehicle and an intersection contained in a predetermined range from the current position. Then, when the destination is set, the route searching unit 14 executes the routes search to the destination by making use of the route to the intersection contained in the predetermined range searched in advance. In other words, in this embodiment, the route in the periphery of the current position of the vehicle is searched at the stage before the setting of the destination is accepted. In case the destination is set, therefore, the route search from the current position to the intersection can be omitted to resultantly shorten the searching time period for searching the recommended route to the destination.

In this embodiment, moreover, when the navigation system accepts the setting of the destination, and at the stage before the confirmation of whether or not the destination inputted is erroneous is accepted from the user, the route search to the destination is started. Therefore, the search of the recommended route to the destination has already been started in case the confirmation of the destination is accepted from the user. According to this embodiment, therefore, it is possible to shorten the searching time period from the final setting of the destination.

Thus, according to this embodiment, it is possible for the navigation system to shorten the time period from the setting of the destination to the presentation of the recommended route to the user.

Here, the invention should not be limited to the embodiments thus far described, but can be modified in various manners within the scope thereof. In this embodiment, for example, in case the destination is set, the route search is performed by making use of the route searched in advance before the destination was set from the current position to the intersection, but the invention should not be limited to that route search. For example, the route searching unit 14 holds the route candidates, which have not been adopted when the recommended route to the destination was searched, even after the guide of the recommended route finally adopted was started. In case a deviation of the vehicle is detected, moreover, the route searching unit 14 may search again the route to the destination by making use of the route candidates held. By thus using again the route candidates once searched, it is possible to shorten the searching time period for the auto-rerouting.

In this embodiment, moreover, the route from the current position to the intersection within a predetermined position is searched at the stage before setting of the destination, but the route search should not be limited thereto. For example, the search may also be performed for the route from the current position to a main road.

What is claimed is:

1. A route searching method in a navigation system mounted on a vehicle which searches a recommended route to a destination by using link information,
characterized in that the navigation system executes:
the step of detecting a stop of the vehicle;
the step of detecting a current position of the vehicle in case the stop of the vehicle is detected or in case the navigation system itself is started;
the step of searching a route from the detected current position to an intersection within a range of a predetermined distance, by using the link information;
the step of accepting a setting of the destination; and
the step of searching a route from the intersection to the destination by using the link information, in case the setting of the destination is accepted, and specifying a route which is composed of the route searched from the current position to the intersection and the route searched from the intersection to the destination, as a recommended route.

2. A route searching method in a navigation system mounted on a vehicle which searches a recommended route to a destination by using link information, wherein
a display device is connected with the navigation system; and
wherein the navigation system executes:
the step of detecting the current position of the vehicle;
the step of accepting an input of the destination from a user;
the step of displaying a screen to accept confirmation from the user whether or not the destination accepted is erroneous, on the display device;
the step of setting the destination in case data indicating that the destination is not erroneous is accepted from the user;
the step of searching the route from the detected current position to the accepted destination by using the link information, before the destination is set, in case the input of the destination is accepted; and
the step of specifying the searched route as a recommended route in case the destination is set.

3. A navigation system mounted on a vehicle which searches a recommended route to a destination by using link information, comprising:
means which detects a stop of the vehicle;
means which detects a current position of the vehicle in case the stop of the vehicle is detected or in case the navigation system itself is started;
means which searches a route from the detected current position to an intersection within a range of a predetermined distance, by using the link information;
means which accepts a setting of the destination; and
means which searches a route from the intersection to the destination by using the link information, in case the setting of the destination is accepted, to specify a route which is composed of the route searched from the current position to the intersection and the route searched from the intersection to the destination, as a recommended route.

4. A navigation system mounted on a vehicle which searches a recommended route to a destination by using link information, comprising:
means which detects a current position of the vehicle;
means which accepts an input of the destination from a user;
means which displays information to accept confirmation from the user whether or not the destination accepted is erroneous;
means which sets the destination in case data indicating that the destination is not erroneous is accepted from the user;
means which searches a route from the detected current position to the accepted destination by using the link information, before the destination is set, in case the input of the destination is accepted; and
means which specifies the searched route as a recommended route in case the destination is set.
